(19) United States
(12) Patent Application Publication
(10) Pub. No.: US 2020/0124725 A1
(43) Pub. Date: Apr. 23, 2020

(54) NAVIGABLE REGION RECOGNITION AND TOPOLOGY MATCHING, AND ASSOCIATED SYSTEMS AND METHODS

(71) Applicant: SZ DJI TECHNOLOGY CO., LTD., Shenzhen (CN)

(72) Inventors: Fan QIU, Shenzhen (CN); Lu MA, Shenzhen (CN)

(21) Appl. No.: 16/718,988

(22) Filed: Dec. 18, 2019

Related U.S. Application Data
(63) Continuation of application No. PCT/CN2017/112930, filed on Nov. 24, 2017.

(51) Int. Cl. G01S 17/08; G01S 17/89; G01S 17/931; G01S 7/481; G01S 7/4861

(52) U.S. Cl. CPC G01S 17/08; G01S 17/89; G01S 7/4861; G01S 7/4817; G01S 17/931

(57) ABSTRACT

A method for recognizing navigable regions for a mobile platform includes segregating a plurality of three-dimensional scanning points based at least in part on a plurality of grids referenced relative to a portion of the mobile platform, identifying a subset of scanning points from the plurality of scanning points based at least in part on the segregating of the plurality of scanning points, and recognizing a region navigable by the mobile platform based at least in part on positions of the subset of scanning points. Individual two-dimensional grids are associated with corresponding distinct sets of segregated scanning points. The subset of scanning points indicates one or more obstacles in an environment adjacent to the mobile platform.

### CROSS-REFERENCE TO RELATED APPLICATION

This application is a continuation of International Application No. PCT/CN2017/112930, filed Nov. 24, 2017, the entire content of which is incorporated herein by reference.

### TECHNICAL FIELD

The present technology is generally directed to navigable region recognition and topology matching based on distance-measurement data, such as point clouds generated by one or more emitter/detector sensors (e.g., laser sensors) that are carried by a mobile platform.

### BACKGROUND

The surrounding environment of a mobile platform can typically be scanned or otherwise detected using one or more emitter/detector sensors. Emitter/detector sensors, such as LiDAR sensors, typically transmit a pulsed signal (e.g. laser signal) outwards, detect the pulsed signal reflections, and identify three-dimensional information (e.g., laser scanning points) in the environment to facilitate object detection and/or recognition. Typical emitter/detector sensors can provide three-dimensional geometry information (e.g., a point cloud including scanning points represented in a three-dimensional coordinate system associated with the sensor or mobile platform). Various interferences (e.g., changing ground level, types of obstacles, or the like) and limitations to current locating and/or positioning technologies (e.g., the precision of GPS signals) can affect routing and navigation applications. Accordingly, there remains a need for improved processing techniques and devices for navigable region recognition and mobile platform locating based on the three-dimensional information.

### SUMMARY

The following summary is provided for the convenience of the reader and identifies several representative embodiments of the disclosed technology.

In some embodiments, a computer-implemented method for recognizing navigable regions for a mobile platform includes segregating a plurality of three-dimensional scanning points based, at least in part, on a plurality of two-dimensional grids referenced relative to a portion of the mobile platform, wherein individual two-dimensional grids are associated with corresponding distinct sets of segregated scanning points. The method also includes identifying a subset of the plurality of scanning points based, at least in part, on the segregating of the plurality of scanning points, wherein the subset of scanning points indicates one or more obstacles in an environment adjacent to the mobile platform. The method further includes recognizing a region navigable by the mobile platform based, at least in part, on positions of the subset of scanning points.

In some embodiments, the two-dimensional grids are based, at least in part, on a polar coordinate system centered on the portion of the mobile platform and segregating the plurality of scanning points comprises projecting the plurality of scanning points onto the two-dimensional grids. In some embodiments, the two-dimensional grids include divided sectors in accordance with the polar coordinate system. In some embodiments, the plurality of scanning points indicate three-dimensional environmental information about at least a portion of the environment surrounding the mobile platform.

In some embodiments, identifying the subset of scanning points comprises determining a base height with respect to an individual grid. In some embodiments, identifying the subset of scanning points further comprises filtering scanning points based, at least in part, on a comparison with the base height of individual grids. In some embodiments, identifying the subset of scanning points further comprises filtering out scanning points that indicate one or more movable objects. In some embodiments, the movable objects include at least one of a vehicle, motorcycle, bicycle, or pedestrian.

In some embodiments, recognizing the region navigable by the mobile platform comprises transforming the subset of scanning points into obstacle points on a two-dimensional plane. In some embodiments, recognizing the region navigable by the mobile platform further comprises evaluating the obstacle points based, at least in part, on their locations relative to the mobile platform on the two-dimensional plane. In some embodiments, the region navigable by the mobile platform includes an intersection of roads.

In some embodiments, the mobile platform includes at least one of an unmanned aerial vehicle (UAV), a manned aircraft, an autonomous car, a self-balancing vehicle, a robot, a smart wearable device, a virtual reality (VR) head-mounted display, or an augmented reality (AR) head-mounted display. In some embodiments, the method further includes causing the mobile platform to move within the recognized region.

In some embodiments, a computer-implemented method for locating a mobile platform includes obtaining a set of obstacle points indicating one or more obstacles in an environment adjacent to the mobile platform and determining a first topology of a navigable region based, at least in part, on a distribution of distances between the set of obstacle points and the mobile platform. The method also includes pairing the first topology with a second topology, wherein the second topology is based, at least in part, on map data.

In some embodiments, the set of obstacle points is represented on a two-dimensional plane. In some embodiments, the navigable region includes at least one intersection of a plurality of roads. In some embodiments, determining the first topology comprises determining one or more angles formed by the plurality of roads at the intersection. In some embodiments, determining the first topology comprises determining local maxima within the distribution of distances.

In some embodiments, the first and second topologies are represented as vectors. In some embodiments, pairing the first topology with a second topology comprises a loop matching between the first topology vector and the second topology vector.

In some embodiments, obtaining the set of obstacle points comprises obtaining the set of obstacle points based, at least in part, on data produced by one or more sensors of the mobile platform. In some embodiments, the map data includes GPS navigation map data. In some embodiments, the method further includes locating the mobile platform within a reference system of the map data based, at least in part, on the pairing.

Any of the foregoing methods can be implemented via a non-transitory computer-readable medium storing computer-executable instructions that, when executed, cause one or more processors associated with a mobile platform to perform corresponding actions, or via a vehicle including a programmed controller that at least partially controls one or more motions of the vehicle and that includes one or more processors configured to perform corresponding actions.

### BRIEF DESCRIPTION OF THE DRAWINGS

FIG. 1A illustrates a three-dimensional scanning point within a three-dimensional coordinate system associated with an emitter/detector sensor (or a mobile platform that carries the sensor).

FIG. 1B illustrates a point cloud 120 generated by an emitter/detector sensor.

FIG. 2 is a flowchart illustrating a method for recognizing a region navigable by a mobile platform, in accordance with some embodiments of the presently disclosed technology.

FIG. 3 illustrates a polar coordinate system with its origin centered at a portion of the mobile platform, in accordance with some embodiments of the presently disclosed technology.

FIG. 4 illustrates a process for determining ground heights, in accordance with some embodiments of the presently disclosed technology.

FIGS. 5A-5C illustrate a process for analyzing obstacles, in accordance with some embodiments of the presently disclosed technology.

FIGS. 6A and 6B illustrate a process for determining a region navigable by a mobile platform, in accordance with some embodiments of the presently disclosed technology.

FIG. 7 is a flowchart illustrating a method for determining a topology of a portion of a region navigable by a mobile platform, in accordance with some embodiments of the presently disclosed technology.

FIG. 8 illustrates a process for generating a distribution of distances between a mobile platform and obstacles, in accordance with some embodiments of the presently disclosed technology.

FIG. 9 illustrates angles formed between intersecting roads, in accordance with some embodiments of the presently disclosed technology.

FIG. 10 is a flowchart illustrating a method for locating a mobile platform based on topology matching, in accordance with some embodiments of the presently disclosed technology.

FIG. 11 illustrates example topology information obtainable from map data.

FIG. 12 illustrates examples of mobile platforms configured in accordance with various embodiments of the presently disclosed technology.

FIG. 13 is a block diagram illustrating an example of the architecture for a computer system or other control device that can be utilized to implement various portions of the presently disclosed technology.

### DETAILED DESCRIPTION

### 1. Overview

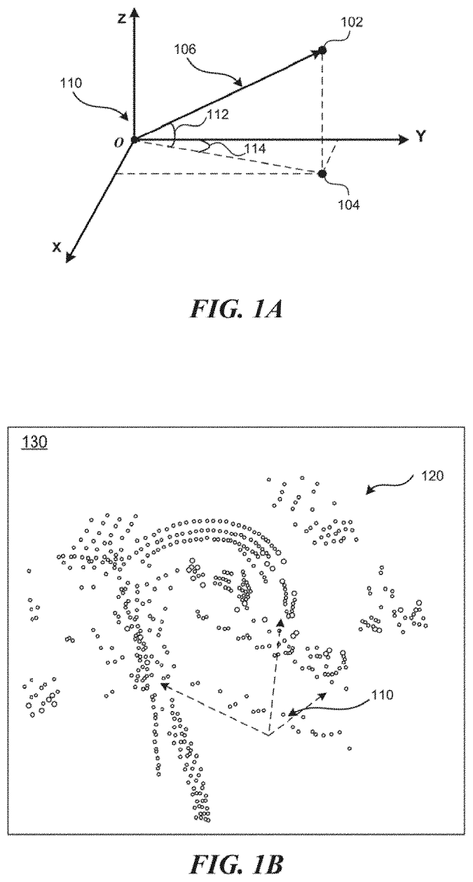

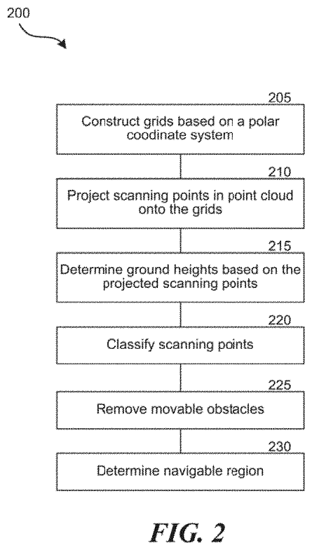

Emitter/detector sensor(s) (e.g., a LiDAR sensor), in many cases, provide base sensory data to support unmanned environment perception and navigation. Illustratively, a LiDAR sensor can measure the distance between the sensor and a target using laser that travels in the air at a constant speed. FIG. 1A illustrates a three-dimensional scanning point 102 in a three-dimensional coordinate system 110 associated with an emitter/detector sensor (or a mobile platform that carries the sensor). As used herein, a three-dimensional scanning point can have a position in a three-dimensional space (e.g., coordinates in a three-dimensional coordinate system), and a two-dimensional scanning point can be the projection of a three-dimensional scanning point onto a two-dimensional plane. Illustratively, the three-dimensional scanning point 102 can be projected to the XOY plane of the coordinate system 110 as a two-dimensional point 104. Given a distance d between the scanning point 102 and the origin O of the coordinate system 110 and the angles (e.g., angles 112 and 114) of a line (e.g., a corresponding laser beam line 106) that connects the scanning point 102 and the origin point O, the two-dimensional coordinates of projected point 104 can be calculated.

FIG. 1B illustrates a point cloud 120 generated by an emitter/detector sensor. Illustratively, the point cloud 120 is represented in accordance with the three-dimensional coordinate system 110 and includes multiple scanning points, such as a collection or accumulation (e.g., a frame 130) of scanning points 102 generated by the emitter/detector sensor during a period of time. A mobile platform can carry one or more emitter/detector sensors to scan its adjacent environment and obtain one or more corresponding point clouds. As used herein, the adjacent environment refers generally to the region in which the emitter/detector sensor(s) is located, and/or has access for sensing. The adjacent environment can extend for a distance away from the sensor(s), e.g., at least partially around the sensor(s), and the adjacent environment may not need to abut the sensor(s).

The presently disclosed technology includes methods and systems for processing one or more point clouds, recognizing regions that are navigable by the mobile platform, and pairing the topology of certain portion(s) or type(s) of the navigable region (e.g., road intersections) with topologies extracted or derived from map data to locate the mobile platform with enhanced accuracy.

Several details describing structures and/or processes that are well-known and often associated with scanning platforms (e.g., UAVs and/or other types of mobile platforms) and corresponding systems and subsystems, but that may unnecessarily obscure some significant aspects of the presently disclosed technology, are not set forth in the following description for purposes of clarity. Moreover, although the following disclosure sets forth several embodiments of different aspects of the presently disclosed technology, several other embodiments can have different configurations or different components than those described herein. Accordingly, the presently disclosed technology may have other embodiments with additional elements and/or without several of the elements described below with reference to FIGS. 1A-13.

FIGS. 1A-13 are provided to illustrate representative embodiments of the presently disclosed technology. Unless provided for otherwise, the drawings are not intended to limit the scope of the claims in the present application.

Many embodiments of the technology described below may take the form of computer- or controller-executable instructions, including routines executed by a programmable computer or controller. The programmable computer or controller may or may not reside on a corresponding scanning platform. For example, the programmable computer or controller can be an onboard computer of the scanning platform, or a separate but dedicated computer associated with the scanning platform, or part of a network or cloud based computing service. Those skilled in the relevant art will appreciate that the technology can be practiced on computer or controller systems other than those shown and described below. The technology can be embodied in a special-purpose computer or data processor that is specifically programmed, configured or constructed to perform one or more of the computer-executable instructions described below. Accordingly, the terms “computer” and “controller” as generally used herein refer to any data processor and can include Internet appliances and handheld devices (including palm-top computers, wearable computers, cellular or mobile phones, multi-processor systems, processor-based or programmable consumer electronics, network computers, mini computers and the like). Information handled by these computers and controllers can be presented at any suitable display medium, including an LCD (liquid crystal display). Instructions for performing computer- or controller-executable tasks can be stored in or on any suitable computer-readable medium, including hardware, firmware or a combination of hardware and firmware. Instructions can be contained in any suitable memory device, including, for example, a flash drive, USB (universal serial bus) device, and/or other suitable medium. In particular embodiments, the instructions are accordingly non-transitory.

### 2. Representative Embodiments

FIG. 2 is a flowchart illustrating a method 200 for recognizing a region navigable by a mobile platform, in accordance with some embodiments of the presently disclosed technology. The method 200 can be implemented by a controller (e.g., an onboard computer of the mobile platform, an associated computing device, and/or an associated computing service).

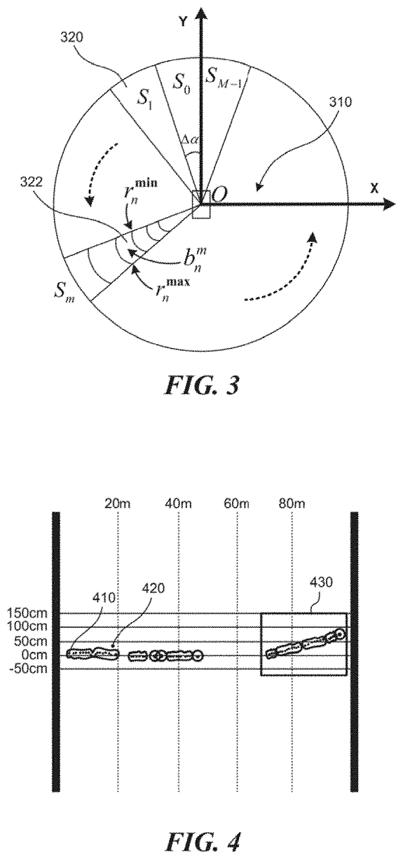

At block 205, the method includes constructing various grids based on a polar coordinate system. For example, FIG. 3 illustrates a polar coordinate system 310 with its origin O centered at a portion (e.g., the centroid) of the mobile platform, in accordance with some embodiments of the presently disclosed technology. Illustratively, the polar coordinate system 310 corresponds to an X-Y plane and a corresponding Z-axis (not shown) points outwards from the origin O toward a reader of the Figure. The controller can divide the 360 degrees (e.g., around the Z-axis) of the polar coordinate system 310 into M sectors 320 of equal or unequal sizes. The controller can further divide each sector 320 into N grids 322 of equal or unequal lengths along the radial direction. Illustratively, the radial-direction length of an individual grid bₙ^{m} can be expressed as:

Δb=rₙ^{max}−rₙ^{min}

where rₙ^{max},rₙ^{min} correspond to distances from the far and near boundaries of the grid to the origin O.

At block 210, the method includes projecting three-dimensional scanning points of one or more point clouds onto the grids. Illustratively, the controller calculates x-y or polar coordinates of individual scanning point projections in the polar coordinate system, and segregates the scanning points into different groups that correspond to individual grids (e.g., using the grids to divide up scanning point projections in the polar coordinate system). For each grid bₙ^{m}, the controller can determine the height values (e.g., z-coordinate values) of the scanning points that are grouped therein. The controller can select a smallest height value zₙ^{m} as representing a possible ground height of the grid bₙ^{m}.

At block 215, the method includes determining ground heights based on the projection of the scanning points. In some embodiments, the controller implements suitable clustering methods, such as diffusion-based clustering methods, to determine ground heights for individual grids. FIG. 4 illustrates a process for determining ground heights, in accordance with some embodiments of the presently disclosed technology. With reference to FIG. 4, possible ground heights zₙ^{m} for grids belonging to a particular sector in a polar coordinate system (e.g., coordinate system 310 of FIG. 3) are represented as black dots in the graph. Starting from a grid that is closest to the polar coordinate origin O, the controller selects a first height value zₙ^{m} 410 that is smaller than a threshold height T₀ (e.g., between 20 and 30 cm) and labels the first qualified height value zₙ^{m} 410 as an initial estimated ground height \hat{z}ₙ^{m}. Starting from the grid corresponding to the initial estimated ground height \hat{z}ₙ^{m} the controller can perform a diffusion-based clustering of all possible ground heights along a direction (e.g., the n+1 direction) away from the polar coordinate origin O, and determine ground heights (e.g., \hat{z}ₙ₊₁^{m}) for other grids in the particular sector. The conditions for the diffusion based clustering can be expressed as:

if |zₙ₊₁^{m}−\hat{z}ₙ^{m}|<T_{g}*((rₙ^{min}+rₙ^{max})/2/100+1) then \hat{z}ₙ₊₁^{m}=zₙ₊₁^{m};

else \hat{z}ₙ₊₁^{m}=\hat{z}ₙ^{m}.

where T_{g} corresponds to a constant value (e.g., between 0.3 m and 0.5 m), and the term T_{g}*((rₙ^{min}+rₙ^{max})/2/100+1) provides a higher threshold for a grid farther from the origin O so as to adapt to a potentially sparser distribution of scanning points farther from the origin O. As illustrated in FIG. 4, the process can accommodate uphill (and similarly downhill) ground contours 430 as well as filter out nonqualified ground height(s) 420.

Referring back to FIG. 2, at block 220, the method includes classifying scanning points in accordance with the plurality of grids. Illustratively, the controller can classify scanning points associated with each grid, based on the determined ground heights \hat{z}ₙ^{m}. For each grid, a scanning point with a height value (e.g., z-coordinate value) zᵢ can be classified to indicate whether it represents a portion of an obstacle, for example, based on the following conditions using the determine ground heights:

if |\hat{z}ₙ^{m}−zᵢ|<T_{g} then zᵢ represents non-obstacle (e.g., ground);

else zᵢ represents obstacle.

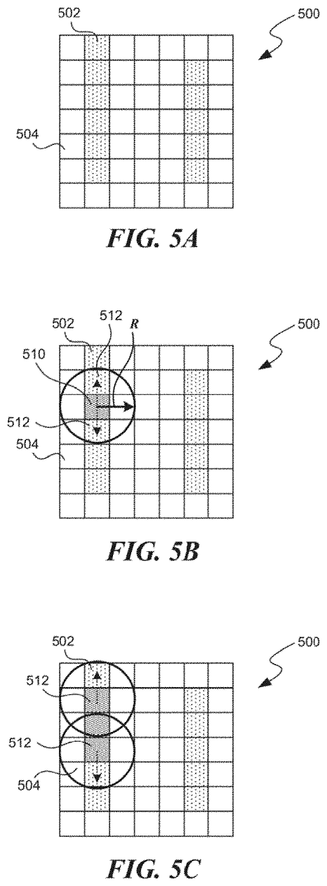

With continued reference to FIG. 2, at block 225, the method includes removing movable obstacles from the analysis. Illustratively, the controller can filter out scanning points that do not represent obstacles and then analyze scanning points that represent obstacles. FIGS. 5A-5C illustrate a process for analyzing obstacles, in accordance with some embodiments of the presently disclosed technology. With reference to FIG. 5A, the controller divides the environment adjacent to the mobile platform into N by N two-dimensional analysis grids 500 (e.g., N=1000 and the size of each grid is 0.1 m by 0.1 m) centered at a portion (e.g., the centroid) of the mobile platform. The controller projects or otherwise transforms scanning points that represent portions of obstacles onto the analysis grids and labels each grid as an obstacle grid 502 or a non-obstacle grid 504 based, for example, on whether the grid includes a threshold quantity of projected scanning points.

With reference to FIGS. 5B and 5C, the controller clusters the obstacle grids based on the following algorithm:
(1) Let a growth radius be R and mark all obstacle grids as “unvisited”;
(2) Select an “unvisited” grid 510 as a seed for growth-based clustering and mark the selected grid as “visited”;
(3) Detect obstacle grid(s) 512 within a radius R of the seed, group the detected obstacle grid(s) 512 as belonging to a same obstacle object as the seed, and mark the detected obstacle grid(s) 512 as “visited” and use it/them as new seed(s) for further clustering;
(4) If no further obstacle grid(s) can be detected as belonging to the obstacle object, clustering for the obstacle object ends;
(5) If there exits at least one “unvisited” grid, proceed to (2) for clustering with respect to another obstacle object; otherwise, the clustering process ends.

The controller then analyzes the clustered obstacle grids. Illustratively, the controller can determine an estimated obstacle shape (e.g., an external parallelogram) for each cluster. In some embodiments, the controller can compare various attributes of the shape (e.g., proportions of sides and diagonal lines) with one or more thresholds to determine whether the cluster represents a movable object (e.g., a vehicle, bicycle, motorcycle, or pedestrian) that does not affect the navigability (e.g., for route planning purposes) of the mobile platform. The controller can filter out analysis grids (or scanning points) that correspond to movable obstacles and retain those that reflect or otherwise affect road structures (e.g., buildings, railings, fences, shrubs, trees, or the like).

In some embodiments, the controller can use other techniques (e.g., random decision forests) to classify obstacle objects. For example, random decision forests that have been properly trained with labeled data can be used to classify clustered scanning points (or clustered analysis grids) into different types of obstacle objects (e.g., a vehicle, bicycle, motorcycle, pedestrian, build, tree, railings, fences, shrubs, or the like). The controller can then filter out analysis grids (or scanning points) of obstacles that do not affect the navigability of the mobile platform. In some embodiments, the controller filters out scanning points that represent movable objects, for example, by applying a smoothing filter on a series of scanning point clouds

Referring back to FIG. 2, at block 230, the method includes determining navigable region(s) for the mobile platform. Illustratively, the controller analyzes projected or otherwise transformed scanning points or analysis grids that represent obstacles on a two-dimensional plane (e.g., the x-y plane of FIG. 3 or the analysis grids plane of FIGS. 5A-5C) centered at a portion (e.g., the centroid) of the mobile platform.

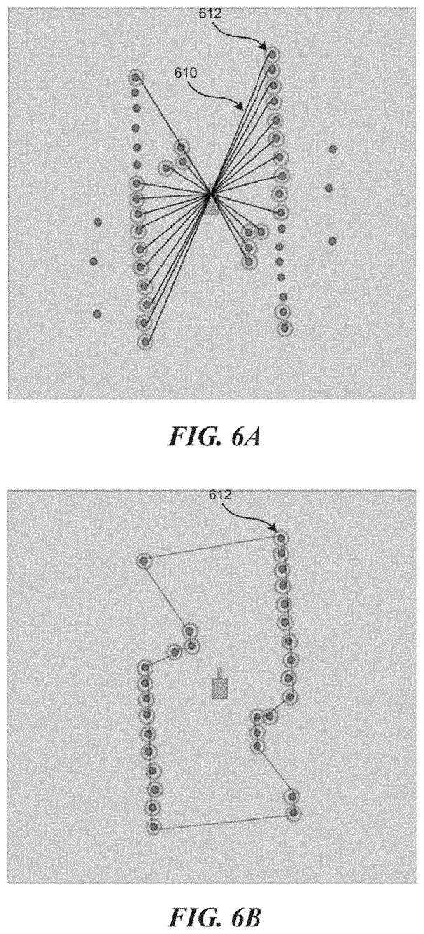

FIGS. 6A and 6B illustrate a process for determining a region navigable by the mobile platform, in accordance with some embodiments of the presently disclosed technology. With reference to FIG. 6A, the controller establishes a plurality of virtual beams or rays 610 (e.g., distributed over 360 degrees in an even or uneven manner) from the center of the plane outward. The virtual beams or rays 610 are not real and do not have a physical existence. Rather, they are logical lines that originate from the center of the plane. Each virtual beam 610 ends where it first comes into contact with an obstacle point or grid. In other words, a length of an individual virtual beam 610 represents the distance between the mobile platform and a portion of a closest obstacle in a corresponding direction. Therefore, the virtual beam end points 612 are considered boundary points (e.g., side of a road) of the navigable region. With reference to FIG. 6B, the controller connects the end points 612 of the virtual beams 610 in a clockwise or counter-clockwise order and labels the enclosed region as navigable by the mobile platform. In some embodiments, various suitable interpolation, extrapolation, and/or other fitting techniques can be used to connect the end points and determine the navigable region. Once the navigable region is determined, the controller can generate route planning instructions or otherwise guide the mobile platform to move within the navigable region.

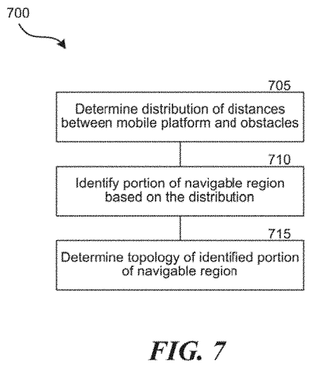

FIG. 7 is a flowchart illustrating a method 700 for determining a topology of a portion of a region navigable by a mobile platform, in accordance with some embodiments of the presently disclosed technology. The method 700 can be implemented by a controller (e.g., an onboard computer of the mobile platform, an associated computing device, and/or an associated computing service).

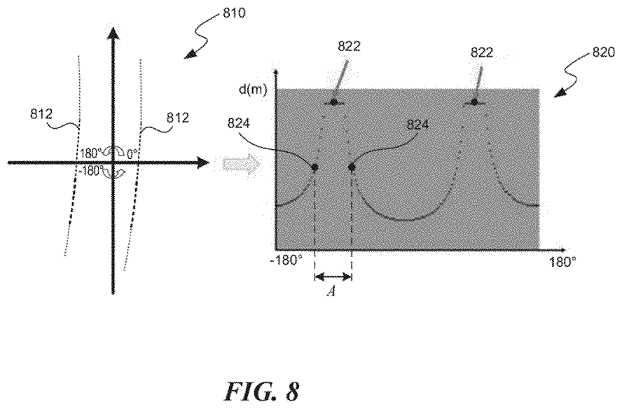

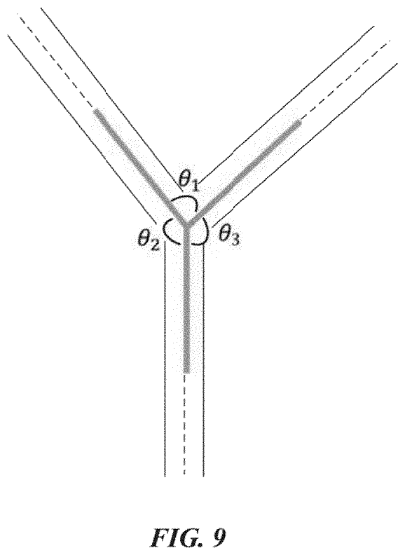

At block 705, the method includes determining a distribution of distances between the mobile platform and obstacles. Similar to block 225 of method 200 described above with reference to FIG. 2, the controller can analyze projected scanning points or analysis grids that represent obstacles on a two-dimensional plane centered at a portion (e.g., the centroid) of the mobile platform. For example, FIG. 8 illustrates a process for generating a distribution of distances between the mobile platform and obstacles, in accordance with some embodiments of the presently disclosed technology. With reference to FIG. 8, a two-dimensional plane 810 includes projected scanning points 812 that represent obstacles (e.g., road sides). Similar to the process of FIGS. 6A and 6B, the controller can establish a plurality of virtual beams or rays (e.g., distributed over 360 degrees in an even or uneven manner) that originate from the center of the plane 810 (e.g., corresponding to the center of a mobile platform or an associated sensor) and end at a closest obstacle point in corresponding directions. The controller can then generate a distribution 820 of distances d represented by the virtual beams' lengths along a defined angular direction (e.g., −180° to 180° in a clockwise or counter-clockwise direction). In some embodiments, obstacle information (e.g., locations of obstacles) can be provided by another system or service which may or may not use emitter/detector sensor(s). For example, obstacles can be detected based on stereo-camera or other vision sensor based systems.

At block 710, the method includes identifying a particular portion (e.g., an intersection of roads) of the navigable region based on the distribution. Illustratively, the controller can determine road orientations (e.g., angular positions with respect to the center of the plane 810). For example, the controller searches for local maxima (e.g., peak distances) in the distribution and label their corresponding angular positions as candidate orientations of the roads that cross with one another at an intersection. As illustrated in FIG. 8, in some embodiments, because actual distances in the orientation of a road may extend toward infinity and there may not be corresponding scanning point(s) to explicitly reflect this situation, candidate road orientations 822 corresponding to peak distances can be determined based on interpolation and/or extrapolation (e.g., mid-point in a gap between two maxima points). The controller can filter out “fake” orientations of roads (e.g., a recessed portion of a road, a narrow alley not passable by the mobile platform, a road with a middle isolation zone mistaken for two roads, or the like) using the following rules:
(1) Exclude candidate road orientations associated with a respective local maximum distance d that is smaller than a threshold distance Td;
(2) Calculate an opening width A for each candidate road orientation (e.g., A calculated as an angular difference between two virtual beam angles 824, each associated with ½ of a particular local maximum distance d, that are closest to the candidate road orientation associated with d), and exclude candidate road orientations having an opening width A larger than a threshold width Tai and/or smaller than a threshold width Tae;
(3) If the angle between two adjacent candidate road orientations is smaller than a certain threshold Tb, exclude the candidate road orientation with a smaller opening width A.

Various other rules can be used to filter out “fake” orientations of roads. For example, the opening width A for each candidate road orientation can be calculated differently (e.g., including a weight factor, based on two virtual beam angles asymmetrically distanced from the candidate road orientation, or the like.) As another example, if the angle between two adjacent candidate road orientations is smaller than a certain threshold Tb, the two adjacent candidate road orientations can be consider belonging to a same road, which can be associated with a new road orientation estimated by taking an average, weighted average, or other mathematical operation(s) of the two adjacent candidate road orientations.

At block 715, the method includes determining the topology of the identified portion (e.g., an intersection of roads) of the navigable region. In some embodiments, the controller uses a vector defined by angles to indicate the topology of the identified portion. For example, FIG. 9 illustrates angles θᵢ between adjacent road orientations. In this case, a vector form of the topology can be expressed as (θ₁, θ₂, θ₃). Illustratively, based on the number and angles of the road orientations as determined, the controller can determine a topology type for an intersection, for example, based on the following classification rules:

(1) When the number of road orientations is 2: if the angle between them is within a threshold of 180 degrees, the portion of the navigable region is classified as a straight road; otherwise the portion of the navigable region is classified as a curved road.

(2) When the number of road orientations is 3: if at least one angle between two adjacent road orientations is smaller than 90 degrees, the portion of the navigable region is classified as a Y-junction; otherwise the portion of the navigable region is classified as a T-junction.

(3) When the number of road orientations is 4: if at least one angle between two adjacent road orientations is smaller than 90 degrees, the portion of the navigable region is classified as an X-junction; otherwise the portion of the navigable region is classified as a +− junction.

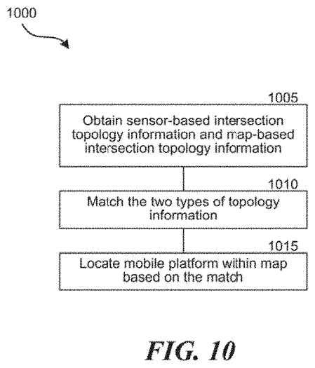

In various navigation applications, the positioning information of a mobile platform (e.g., generated by a GPS receiver) is typically converted into digital map coordinates used by the navigation application, thereby facilitating locating the mobile platform on the digital map for route planning. However, technologies such as GPS positioning can be inaccurate. For example, when a vehicle is traveling on the road, the positioning coordinates received by the vehicle GPS receiver do not necessarily fall on a corresponding path of the digital map, and there can exist a random deviation within a certain range of the true location of the vehicle. The deviation can cause route planning inconsistencies, errors, or other unforeseen risks. FIG. 10 is a flowchart illustrating a method 1000 for locating a mobile platform based on topology matching, in accordance with some embodiments of the presently disclosed technology. The method 1000 can be implemented by a controller (e.g., an onboard computer of the mobile platform, an associated computing device, and/or an associated computing service).

At block 1005, the method includes obtaining sensor-based topology information and map-based topology information. Illustratively, the controller obtains topology information based on sensor data (e.g., point clouds) regarding a portion of a navigable region (an intersection that the mobile platform is about to enter), for example, using method 700 as illustrated in FIG. 7. As discussed above, the sensor-based topology information can be expressed as a vector vₛₑₙₛₒᵣ=(θ₁, θ₂, . . . θₙ), where θ₁, θ₂, . . . θₙ correspond to respective angles between two adjacent road orientations in a clockwise (or counter-clockwise) order around the intersection.

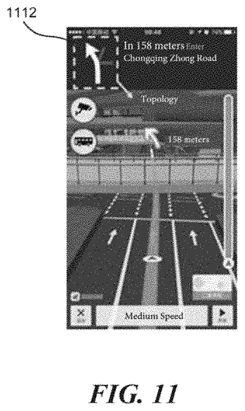

The controller also obtains topology information based on map data (e.g., GPS maps). For example, as illustrated in FIG. 11, various GPS navigation systems or apps can generate an alert before a mobile platform enters an intersection. The controller can obtain the topology 1112 of the intersection via an API interface to the navigation system/app in response to detecting the alert. In some embodiments, the controller can search an accessible digital map to identify a plurality of intersections within a search area, and derive topologies corresponding to the identified intersections. The search area can be determined based on a precision limit or other constraints of the applicable locating system or method under certain circumstances (e.g., at the initiation of GPS navigation, when driving through a metropolitan area, or the like). Similarly, a map-based topology can be expressed as a vector vₘₐₚ=(θ₁, θ₂, . . . θₘ), where θ₁, θ₂, . . . θₘ correspond to respective angles between two adjacent road orientations in a clockwise (or counter-clockwise) order around the intersection.

At block 1010, the method includes pairing the sensor-based topology information with the map-based topology information. Because the reference systems (e.g., coordinate systems) for the sensor-based topology and the map-based topology may not necessarily be consistent with each other, absolute matching between the two type of topology information may or may not be implemented. For example, coordinate systems for the two types of topology information can be oriented in different directions and/or based on different scales. Therefore, in some embodiments, the pairing process includes relative, angle-based matching between the two type of topologies. Illustratively, the controller evaluates the sensor-based topology vector vₛₑₙₛₒᵣ against one or more map-based topology vectors vₘₐₚ. The controller can determine that the two topologies match with each other, if and only if 1) the two vectors have an equal number of constituent angles and 2) one or more difference measurements (e.g., cross correlations) that quantify the match are smaller than threshold value(s).

In some embodiments, an overall difference measurement can be calculated based on a form of loop matching or loop comparison between the two sets of angles included in the vectors. In a loop matching or loop comparison between two vectors of angles, the controller keeps one vector fixed and “loops” the angles included in the other vector for comparison with the fixed vector. For example, given vₛₑₙₛₒᵣ=(30°,120°,210°) and vₘₐₚ=(110°,200°,50°), the controller can keep vₘₐₚ fixed and compare 3 “looped” versions of vₛₑₙₛₒᵣ (i.e., (30°,120°,210°), (120°,210°,30°), and (210°,30°,120°)) with vₛₑₙₛₒᵣ. More specifically, the controller can perform a loop matching or loop comparison as follows:
   |30−110|+|120−200|+|210−50|=320
   |120−110|+|210−200|+|30−50|=40
   |210−110|+|30−200|+|120−50|=340

As illustrated above, loop matching or loop comparison can determine multiple candidates for a difference measurement by “looping” constituent angles (thus maintaining their circular order) of one vector while keeping the order of constituent angles for another vector. In some embodiments, the controller selects the candidate of minimum value 40 as an overall difference measurement for the pairing between vₛₑₙₛₒᵣ and vₘₐₚ. Various suitable loop matching or loop comparison methods (e.g., square-error based methods) can be used to determine the overall difference measurement. If the overall difference measurement is smaller than a threshold, the pairing process can be labeled a success.

An example of pseudo code for implementing loop matching or loop comparison is shown below:

```
#define ERROR_THRES 5
bool match(std::vector<float> v1, std::vector<float> v2)
{
      if (v1.size( ) == v2.size( )) //if (n == m)
      {
            float min_err_sum = 999999.0f;
            for (int i = 0; i < v1.size( ); ++i)
            {
                  float err_sum = 0.0f;
                  for (int j = 0; j < v2.size( ); ++j)
                  {
                        int new_i = i + j;
                        if (new_i >= v1.size( ))
                        {
                              new_i −= v1.size( );
                        }
                        err_sum += fabs(v1[new_i] − v2[j]);
                  }
                  if (err_sum < min_err_sum)
                  {
                        min_err_sum = err_sum;
                  }
            }
            if (min_err_sum < v1.size( ) * ERROR_THRES)
            {
                  return true;
            }
            else
            {
                  return false;
            }
      }
      else
      {
            return false;
      }
}
```

In some embodiments, multiple angular difference measurements are further calculated between corresponding angles of the two vectors. For example, in accordance with the overall difference measurement of 40 as discussed above, (10, 10, 20) describes multiple angular difference measurements in a vector form. Accordingly, multiple thresholds can each be applied to a distinct angular difference measurement for determining whether the pairing is successful. In embodiments where there is more than one map-based topology (e.g., multiple vₘₐₚ values) for pairing, the controller can rank the pairings based on their corresponding difference measurement(s) and select a map-based topology with a smallest difference measurement(s) and to further determine whether the pairing is successful. In some embodiments, the matching or pairing between two vectors of angles can be based on pairwise comparison between angle values of the two vector. For example, the controller can compare a fixed first vector of angles against different permutations of angles included in a second vector (e.g., regardless of circular order of the angles).

At block 1015, the method includes locating the mobile platform within a reference system of the map data. Given the paired topologies, the current location of the mobile platform can be mapped to a corresponding location in a reference system (e.g., a coordinate system) of an applicable digital map. For example, the corresponding location can be determined based on a distance between the mobile platform and a paired intersection included in the map data. In some embodiments, the controller can instruct the mobile platform to perform actions (e.g., move straight, make left or right turns at certain point in time, or the like) in accordance with the corresponding location of the mobile platform. In some embodiments, positioning information determined by a navigation system or method (e.g., GPS-based navigation) can be calibrated, compensated, or otherwise adjusted based on the pairing to become more accurate and reliable with respect to the reference system of the map data. For example, the controller can use the pairing to determine whether the mobile platform reaches a certain intersection on a map, with or without GPS positioning, thus guiding the mobile platform to smoothly navigate through the intersection area. In some embodiments, if the topology pairing is unsuccessful, the controller can guide the motion of the mobile platform using one or more sensors (e.g. LiDAR) without map information.

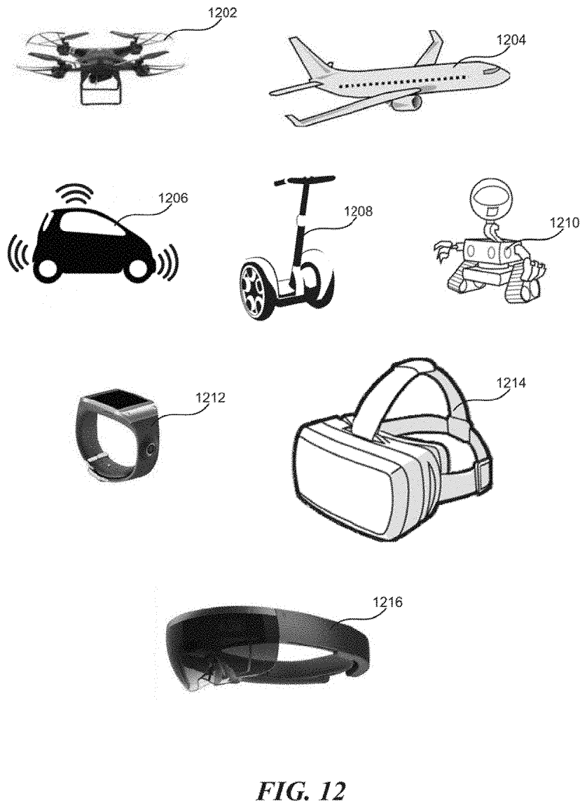

FIG. 12 illustrates examples of mobile platforms configured in accordance with various embodiments of the presently disclosed technology. As illustrated, a representative scanning platform as disclosed herein may include at least one of an unmanned aerial vehicle (UAV) 1202, a manned aircraft 1204, an autonomous car 1206, a self-balancing vehicle 1208, a terrestrial robot 1210, a smart wearable device 1212, a virtual reality (VR) head-mounted display 1214, or an augmented reality (AR) head-mounted display 1216.

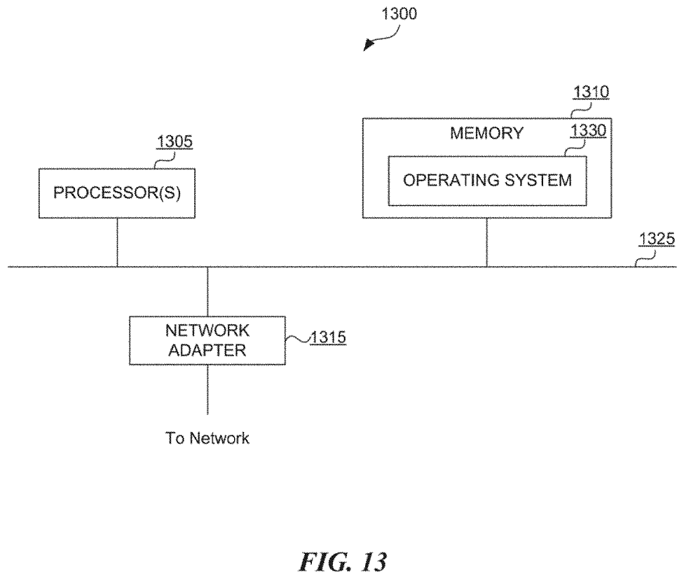

FIG. 13 is a block diagram illustrating an example of the architecture for a computer system or other control device 1300 that can be utilized to implement various portions of the presently disclosed technology. In FIG. 13, the computer system 1300 includes one or more processors 1305 and memory 1310 connected via an interconnect 1325. The interconnect 1325 may represent any one or more separate physical buses, point to point connections, or both, connected by appropriate bridges, adapters, or controllers. The interconnect 1325, therefore, may include, for example, a system bus, a Peripheral Component Interconnect (PCI) bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 674 bus, sometimes referred to as “Firewire.”

The processor(s) 1305 may include central processing units (CPUs) to control the overall operation of, for example, the host computer. In certain embodiments, the processor(s) 1305 accomplish this by executing software or firmware stored in memory 1310. The processor(s) 1305 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 1310 can be or include the main memory of the computer system. The memory 1310 represents any suitable form of random access memory (RAM), read-only memory (ROM), flash memory, or the like, or a combination of such devices. In use, the memory 1310 may contain, among other things, a set of machine instructions which, when executed by processor 1305, causes the processor 1305 to perform operations to implement embodiments of the presently disclosed technology.

Also connected to the processor(s) 1305 through the interconnect 1325 is a (optional) network adapter 1315. The network adapter 1315 provides the computer system 1300 with the ability to communicate with remote devices, such as the storage clients, and/or other storage servers, and may be, for example, an Ethernet adapter or Fiber Channel adapter.

The techniques described herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

While processes or blocks are presented in a given order in this disclosure, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. In addition, while processes or blocks are at times shown as being performed in series, these processes or blocks may instead be performed in parallel, or may be performed at different times. When a process or step is “based on” a value or a computation, the process or step should be interpreted as based at least on that value or that computation.

Some embodiments of the disclosure have other aspects, elements, features, and/or steps in addition to or in place of what is described above. These potential additions and replacements are described throughout the rest of the specification. Reference in this specification to “various embodiments,” “certain embodiments,” or “some embodiments” means that a particular feature, structure, or characteristic described in connection with the embodiment is included in at least one embodiment of the disclosure. These embodiments, even alternative embodiments (e.g., referenced as “other embodiments”) are not mutually exclusive of other embodiments. Moreover, various features are described which may be exhibited by some embodiments and not by others. Similarly, various requirements are described which may be requirements for some embodiments but not other embodiments. For example, some embodiments use data produced by emitter/detector sensor(s), others can use data produced by vision or optical sensors, still others can use both types of data or other sensory data. As another example, some embodiments account for intersection-based pairing, while others can apply to any navigable region, terrain, or structure.

To the extent any materials incorporated by reference herein conflict with the present disclosure, the present disclosure controls.

I/We claim:

1. A computer-implemented method for locating a mobile platform, the method comprising:
constructing a plurality of grids in a polar coordinate system centered on a portion of the mobile platform;
projecting scanning points included in one or more point clouds onto the plurality of grids, wherein the one or more point clouds each indicates three-dimensional environmental information about at least a portion of an environment surrounding the mobile platform;
for scanning points projected onto each grid, selecting a scanning point in accordance with a height criterion relative to a plane of the polar coordinate system;
clustering at least a subset of the selected scanning points;
determining a ground height for individual grids based, at least in part, on the clustering;
identifying one or more obstacle points based, at least in part, on the ground height;
generating a distribution of distances between at least a subset of the obstacle points and the mobile platform;
recognizing a road intersection based, at least in part, on local maxima detected from the distribution;
determining a first topology of the recognized road intersection;
matching the first topology with a second topology of a road intersection derived from map data; and
locating the mobile platform with respect to a reference system associated with the map data based, at least in part, on the matching.

2. A computer-implemented method for recognizing navigable regions for a mobile platform, the method comprising:
segregating a plurality of three-dimensional scanning points based, at least in part, on a plurality of two-dimensional grids referenced relative to a portion of the mobile platform, wherein individual two-dimensional grids are associated with corresponding distinct sets of segregated scanning points;
identifying a subset of scanning points from the plurality of scanning points based, at least in part, on the segregating of the plurality of scanning points, wherein the subset of scanning points indicates one or more obstacles in an environment adjacent to the mobile platform; and
recognizing a region navigable by the mobile platform based, at least in part, on positions of the subset of scanning points.

3. The method of claim 2, wherein the grids are based, at least in part, on a polar coordinate system centered on the portion of the mobile platform and segregating the plurality of scanning points comprises projecting the plurality of scanning points onto the grids on a two-dimensional plane.

4. The method of claim 2, wherein the grids include sectors formed based, at least in part, on angular differences in accordance with the polar coordinate system.

5. The method of claim 4, wherein each sector includes a plurality ones of the grids in a corresponding radial direction in accordance with the polar coordinate system.

6. The method of claim 2, wherein identifying the subset of scanning points comprises determining a base height with respect to an individual grid.

7. The method of claim 6, wherein identifying the subset of scanning points further comprises filtering scanning points based, at least in part, on a comparison with the base height of individual grids.

8. The method of claim 2, wherein identifying the subset of scanning points further comprises filtering out scanning points that indicate one or more movable objects.

9. The method of claim 8, wherein the one or more movable objects include at least one of a vehicle, motorcycle, bicycle, or pedestrian.

10. The method of claim 2, wherein recognizing the region navigable by the mobile platform comprises transforming the subset of scanning points into obstacle points on a two-dimensional plane.

11. The method of claim 10, wherein recognizing the region navigable by the mobile platform further comprises evaluating the obstacle points based, at least in part, on their locations relative to the mobile platform on the two-dimensional plane.

12. The method of claim 2, wherein the region navigable by the mobile platform includes an intersection of roads.

13. The method of claim 2, wherein the mobile platform includes at least one of an unmanned aerial vehicle (UAV), a manned aircraft, an autonomous car, a self-balancing vehicle, a robot, a smart wearable device, a virtual reality (VR) head-mounted display, or an augmented reality (AR) head-mounted display.

14. The method of claim 2, further comprising causing the mobile platform to move within the recognized region.

15. A non-transitory computer-readable medium storing computer-executable instructions that, when executed, cause one or more processors associated with a mobile platform to perform actions, the actions comprising:
segregating a plurality of three-dimensional scanning points based, at least in part, on a plurality of two-dimensional grids referenced relative to a portion of the mobile platform, wherein individual two-dimensional grids are associated with corresponding distinct sets of segregated scanning points;
identifying a subset of scanning points from the plurality of scanning points based, at least in part, on the segregating of the plurality of scanning points, wherein the subset of scanning points indicates one or more obstacles in an environment adjacent to the mobile platform; and
recognizing a region navigable by the mobile platform based, at least in part, on positions of the subset of scanning points.

16. The computer-readable medium of claim 15, wherein the two-dimensional grids are based, at least in part, on a polar coordinate system centered on the portion of the mobile platform and segregating the plurality of scanning points comprises projecting the plurality of scanning points onto the two-dimensional grids.

17. The computer-readable medium of claim 15, wherein the two-dimensional grids include divided sectors in accordance with the polar coordinate system.

18. The computer-readable medium of claim 15, wherein the plurality of scanning points indicate three-dimensional environmental information about at least a portion of the environment surrounding the mobile platform.

19. The computer-readable medium of claim 15, wherein identifying the subset of scanning points comprises determining a base height with respect to an individual grid.

20. The computer-readable medium of claim 19, wherein identifying the subset of scanning points further comprises filtering scanning points based, at least in part, on a comparison with the base height of individual grids.
